(19) United States
(12) Patent Application Publication
(10) Pub. No.: US 2014/0293429 A1
(43) Pub. Date: Oct. 2, 2014

(54) LENS ARRAY, AND METHOD OF MANUFACTURING THE SAME

(71) Applicant: FUJI XEROX CO., LTD., Tokyo (JP)

(72) Inventors: Shin YASUDA, Kanagawa (JP); Keishi SHIMIZU, Kanagawa (JP)

(73) Assignee: FUJI XEROX CO., LTD., Tokyo (JP)

(21) Appl. No.: 14/021,526

(22) Filed: Sep. 9, 2013

(30) Foreign Application Priority Data
Mar. 27, 2013 (JP) 2013-065572

(51) Int. Cl. G02B 27/22; B29D 11/00; G02B 3/00

(52) U.S. Cl. CPC G02B 27/2214; G02B 3/0037; B29D 11/00403
USPC 359/626; 359/619; 359/628; 264/1.7

(57) ABSTRACT

Provided is a lens array including plural lenses, wherein each lens has a curvature in a first direction and a curvature in a second direction which is different from the first direction, the curvatures being different from each other.

### CROSS-REFERENCE TO RELATED APPLICATIONS

This application is based on and claims priority under 35 USC 119 from Japanese Patent Application No. 2013-065572 filed Mar. 27, 2013.

### BACKGROUND

### Technical Field

The present invention relates to a lens array, and a method of manufacturing the same.

### SUMMARY

According to the invention, there is provided a lens array including: plural lenses, wherein each lens has a curvature in a first direction and a curvature in a second direction which is different from the first direction, the curvatures being different from each other.

### BRIEF DESCRIPTION OF THE DRAWINGS

Exemplary embodiments of the present invention will be described in detail based on the following figures, wherein:

FIGS. 1A to 1D are explanatory diagrams showing examples of a lens of which a curvature in the vertical direction is different from the curvature in the horizontal direction;

FIGS. 2A and 2B are explanatory diagrams illustrating principles of 3D and a changing;

FIGS. 3A to 3D are explanatory diagrams showing examples of a method of manufacturing a lens array;

FIG. 4 is a flow chart showing an example of a method of manufacturing a lens array;

FIGS. 5A to 5C are explanatory diagrams showing examples of a square-shaped element lens;

FIGS. 6A to 6D are explanatory diagrams showing examples of a rectangular-shaped element lens;

FIGS. 7A to 7C are explanatory diagrams showing examples of a circular-shaped element lens; and

FIGS. 8A to 8D are explanatory diagrams showing examples of an elliptical-shaped element lens.

### DETAILED DESCRIPTION

First, a preferable technique will be described before describing exemplary embodiments. The description is to make the exemplary embodiments be easily understood.

Hitherto, in a display method using a lens array, it is not possible to have a three-dimensional display (hereinafter, also referred to as 3D) and a changing being co-present on a piece of display medium.

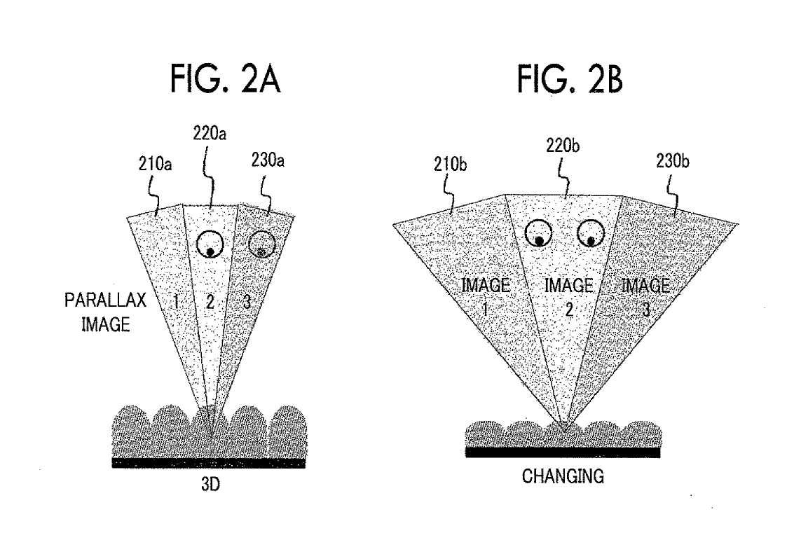

The 3D and the changing are the display media, where a composite image which is configured to include plural images, is arranged on a surface of the lens array. A condition to present respective images configuring the composite image to an observer makes a difference between both media. FIGS. 2A and 2B are explanatory diagrams illustrating principles of the 3D and the changing. As exemplified in FIG. 2A, the 3D portrays a stereoscopic effect (perceived depth) by causing left and right eyes to respectively recognize two images (parallax image 220a and parallax image 230a in FIG. 2A) having a parallax. As the observation angle is changed, the left and right eyes further recognize different pairs of parallax images, thereby expressing a movement parallax and the stereoscopic effect. On the other hand, as exemplified in FIG. 2B, since the changing causes the left and right eyes to recognize the same image (image 220b in FIG. 2B), it is not possible to express the stereoscopic effect. However, the entire image to be recognized may be changed by changing an observation angle. A major factor of such the difference between the 3D and the changing is the difference of focal lengths of the lenses. Generally, a lens having a long focal length (small in lens curvature) is used for the 3D and a lens having a short focal length (large in lens curvature) is used for the changing. The longer the focal length is, the smaller the observation angle at which an image changes. The curvature is the reciprocal of a radius of curvature, while the focal length is proportional to the radius of curvature.

In the lenticular method, an image changes only in one direction which is either the horizontal direction or vertical direction such that only one of either the changing or the 3D may be realized.

A two-dimensional lens array is used in the integral photography method (IP method). Each element lens has one focal length. In the IP method, although the images in the horizontal direction and vertical direction may be changed, since there is one focal length, an image changes at the same angle in any direction. Since the image changing angle for the changing needs to be different from the image changing angle for the 3D, in the related art, only one of either the changing or the 3D may be realized even in the IP method.

Hereinafter, preferable examples of various exemplary embodiments will be described referring to the figures.

As the lens array where the three-dimensional display and the changing image may be displayed on one lens array, the lens array where the curvature in the first direction of each lens configuring the lens array is different from the curvature in the second direction which is different from the first direction will be described. The aforementioned first direction and second direction are, for example, directions substantially orthogonal to each other. For example, in a case of the lens viewed from the upper direction (head on direction), one is the horizontal direction and the other is the vertical direction. In addition to be substantially orthogonal to each other, the directions may have an angle of about 45 degrees or the like.

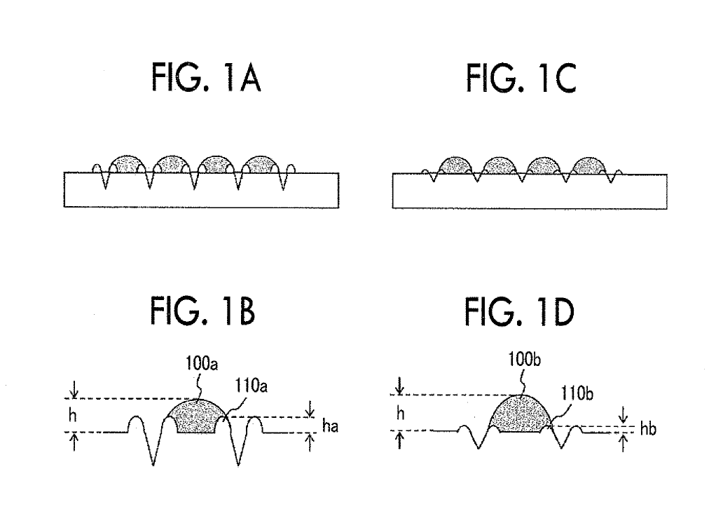

FIGS. 1A to 1D are explanatory diagrams showing examples of the lens of which the curvature in the vertical direction is different from the curvature in the horizontal direction. FIG. 1A shows an example of a cutting surface (horizontal direction) of the lens array. FIG. 1C shows an example of a cutting surface (vertical direction) of the lens array. That is, the cutting surfaces taken from one lens array, which are cut in the horizontal direction and vertical direction passing through the center of the element lenses arranged in column (line), are shown. The example of FIG. 1B shows the cutting surface (horizontal direction) of one lens (also referred to as element lens) among the lens array exemplified in FIG. 1A. The example of FIG. 1D shows the cutting surface (vertical direction) of one element lens among the lens array exemplified in FIG. 10. In this manner, the height (ha) of a partition wall 110a at the end of an element lens 100a of the cutting surface when the element lens is viewed from the horizontal direction is different from the height (hb) of a partition wall 110b at the end of an element lens 100b of the cutting surface viewed from the vertical direction. Accordingly, one lens has different curvatures in the directions which are substantially orthogonal to each other, that is, the focal length varies in the element lens. Further, since the cutting surfaces pass through the center of the same element lens, the element lens has the uniform height. In this example, FIG. 1B illustrates the curvature for the changing (large in curvature), and FIG. 1D illustrates the curvature for the 3D (small in curvature). That is, the lens array is configured to include the element lens having different focal lengths in two directions which are at least substantially orthogonal to each other. The 3D and the changing image may be displayed on a piece of the display medium. For example, as a shape of the element lens, there are a rectangular lens (square-shaped lens) array, an elliptical lens array and the like. As a matter of course, each element lens within the lens array has the same shape.

Next, methods of manufacturing the above-described lens arrays will be described. Mainly, there are two methods as follows.

(1) Manufacturing Using a Mold

For example, manufacturing is carried out by the related art such as injection molding using a mold.

A mold is, for example, the mold for the lens array on which the above-described element lenses differing in curvatures are arranged in a latticed pattern.

(2) Manufacturing by Partition Wall Pinning Method

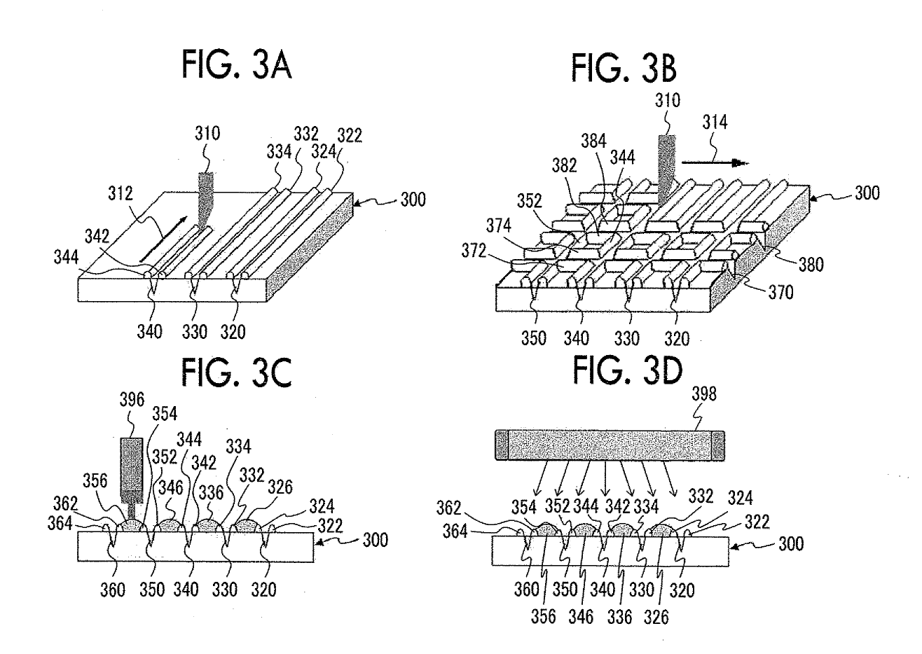

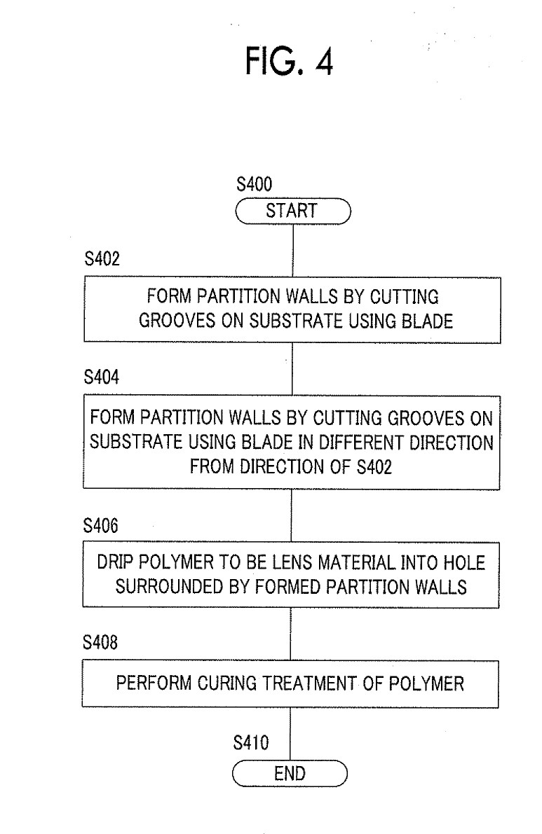

The partition walls are formed to have a latticed pattern in structure. A manufacturing method mainly for the square-shaped lens will be described referring to FIGS. 3A to 3D, and 4. FIGS. 3A to 3D are explanatory diagrams showing examples of the method of manufacturing a lens array. Fig. is a flow chart showing an example of the method of manufacturing a lens array.

In step S402, the partition walls are formed in one direction (vertical direction) as shown in the example of FIG. 3A. That is, the partition walls (partition walls 322, 324, 332, 334, 342, 344 and the like) are formed on a substrate 300 made of a transparent polymer by cutting grooves (grooves 320, 330, 340 and the like) in the vertical direction using a blade 310.

In addition, the substrate 300 and the blade 310 may relatively move with each other (either or both of the substrate 300 and the blade 310 move). That is, partition walls may be formed by sliding the blade 310 on the substrate 300, or by pressing the blade 310 against the substrate 300 (hereinafter, the same will be applied).

In step S404, squared-shaped openings are formed as shown in the example of FIG. 3B. That is, partition walls are formed in a direction which is different from the step S402. The partition walls (partition walls 372, 374, 382, 384 and the like) are formed on the substrate 300 by cutting grooves (grooves 370, 380 and the like) in the horizontal direction using the blade 310. For example, one square-shaped opening is formed by the partition walls 344, 352, 374 and 382.

In addition, the height of the partition walls in the horizontal direction is controlled to be different from the height of the partition walls in the vertical direction. That is, the substrate 300, in which the height of a first partition wall (here, partition wall in the vertical direction) forming a first portion of the periphery of each lens on the lens array is different from the height of a second partition wall (here, partition wall in the horizontal direction) forming a second portion of the periphery of each lens, is manufactured. Specifically, the height of the partition walls is controlled by depth of cut (pressure of the blade 310) on the substrate 300 using the blade 310.

Further, in the step S404, the partition walls are formed by relatively moving the blade 310 with respect to the substrate 300. However, the partition walls may also be formed by pressing a blade (mold) having the square-shaped opening against the substrate. In this case, as the partition walls differ in height with each other, all the blades formed by four blades differ in length with each other in the horizontal direction and vertical direction.

In addition to the square-shaped opening, as a matter of course in this case, a shape of the blade may include a polygonal-shaped opening, (for example, rectangular shape (quadrangular shape differing in length with each other in lengthwise and crosswise), hexagonal shape or the like), a circular-shaped opening, an elliptical-shaped opening and the like. Further, a shape (opening) of the lens represents the shape of an area surrounded by the first partition walls and the second partition walls. In a case of the rectangular shape, as the partition walls differ in height with each other, all the blades formed by four blades differ in length with each other in the horizontal direction and vertical direction. In a case of the hexagonal shape, all the blades formed by six blades differ in length with each other between the blades on three consecutive sides and the blades on the other three consecutive sides. Accordingly, the height of the partition walls on the three consecutive sides is different from the height of the partition walls on the other three consecutive sides. In cases of the circular shape and elliptical shape, as described below referring to FIGS. 7A to 7C and 8A to 8D, the blade is used to cause the partition walls to differ in height in a position substantially orthogonal to each other.

Further, particularly, if a shape of each element lens is the rectangular shape or elliptical shape, as described below referring to FIGS. 6A to 6D and 8A to 8D, since the partition walls may be the same in height with each other, the height of the blades corresponding to the respective sides (periphery) may be the same.

In step S406, as shown in the example of FIG. 3C, a liquid polymer is discharged by a polymer dripping apparatus 396. A region (here, square shape) surrounded by the first partition walls (partition walls 322, 324, 332, 334, 342, 344 and the like) and the second partition walls (partition walls 372, 374, 382, 384 and the like) on the substrate 300 is filled with the liquid polymer (polymers 326, 336, 346, 356 and the like) . That is, the polymer 336, which is a lens material, is dripped into a hole surrounded by the partition walls formed on the substrate 300. An array is formed with the polymers 326, 336, 346, 356 and the like having a lens shape by surface tension of the liquid polymer. At this time, the liquid polymer may be an ultra violet (UV) curable polymer or a hot-melt polymer. The UV curable polymer represents a synthetic polymer which is chemically changed from liquid to solid in reaction to light energy of ultraviolet ray. As the UV curable polymer, an acrylic polymer or an epoxy polymer may be used. Specifically, NOA61 (viscosity 300 cps) and NOA65 (viscosity 1200 cps) manufactured by NORLAND Products Inc. as the acrylic polymer, 3553 (viscosity 1000 cps) manufactured by AZ Electronic Materials Manufacturing Co., Ltd. may be exemplified as the epoxy polymer. NOA61 is employed in the exemplary embodiment.

In step S408, as described in the example of FIG. 3D, curing treatment is performed by UV irradiation of UV light source 398. That is, each lens is formed by performing the curing treatment of the polymer. As a matter of course, the liquid polymer is in a curing state so as to be transparent.

Further, manufacturing using a mold is suitable for mass-production of the same lens array, while the partition wall pinning method is suitable for on-demand production of the lens array which satisfies proposed conditions from a user.

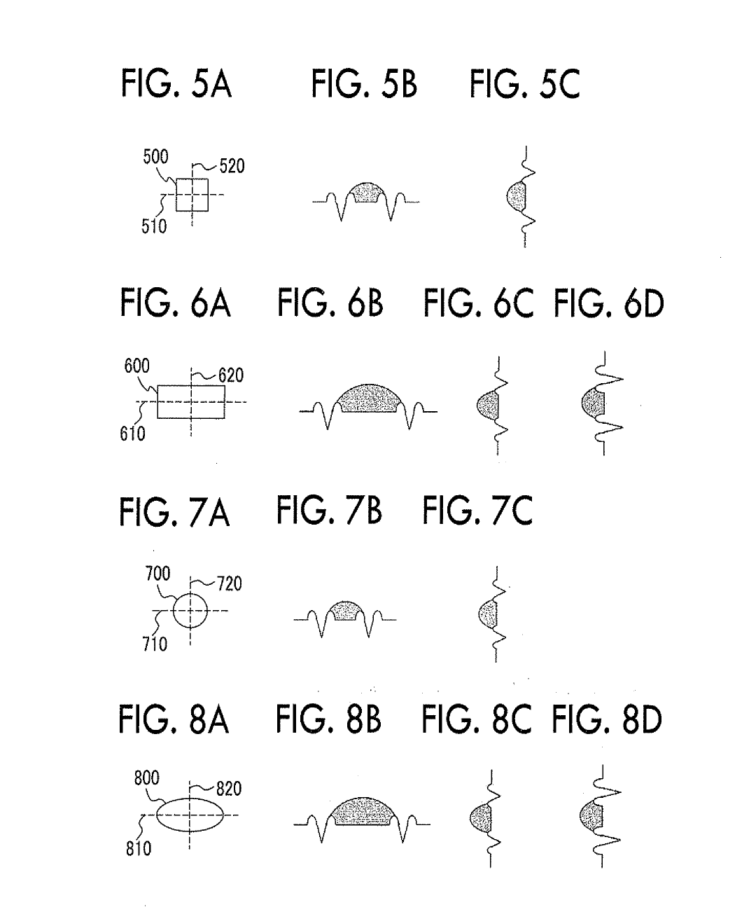

FIGS. 5A to 5C are explanatory diagrams showing examples of the element lens having a square shape. In the square-shaped lens, it shows that the height of the partition walls in the vertical direction is different from the height of the partition walls in the horizontal direction. That is, FIG. 5A shows the shape of the lens viewed from the upper direction (head on direction), and FIGS. 5B and 5C respectively show the shapes of a cutting surface 510 and a cutting surface 520. Since the partition walls differ in height with each other, curvature in the cutting surface 510 is different from the curvature in the cutting surface 520.

FIGS. 6A to 6D are explanatory diagrams showing examples of the element lens having a rectangular shape. In the rectangular-shaped lens, it shows that the height of the partition walls in the vertical direction is different from the height of the partition walls in the horizontal direction, and the partition walls are the same in height with each other in the vertical direction and horizontal direction. That is, FIG. 6A shows the shape of the lens viewed from the upper direction (head on direction), and FIGS. 6B and 6C respectively show the shapes of a cutting surface 610 and a cutting surface 620. The length of the vertical axis is different from the length of the horizontal axis, and the partition walls differ in height with each other. Therefore, the curvature of the cutting surface 610 is different from the curvature of the cutting surface 620. FIGS. 6B and 6D show that the partition walls are the same in height with each other in the vertical direction and horizontal direction. However, the length of the vertical axis is different from the length of the horizontal axis. Therefore, the curvature of the cutting surface 610 is different from the curvature of the cutting surface 620. In this way, in a case where each element lens has a rectangular shape, even if the partition walls have constant height, the curvature in the vertical direction is different from the curvature in the horizontal direction. However, since the curvature thereof depends on aspect ratio of the lens, the degree of design flexibility is small. In order to aggressively control both of the curvatures thereof, it is desirable that the partition walls differ in height with each other, thereby controlling both of the curvatures thereof.

FIGS. 7A to 7C are explanatory diagrams showing examples of element lens having circular shape. In the circular-shaped lens, the partition walls on the circumference are not uniform in height. That is, FIG. 7A shows the shape of the lens viewed from the upper direction (head on direction), and FIGS. 7B and 7C respectively show the shapes of a cutting surface 710 and a cutting surface 720. Since the partition walls differ in height with each other, the curvature of the cutting surface 710 is different from the curvature of the cutting surface 720.

The partition walls thereof may consecutively differ in height. For example, the height of the partition walls may be the greatest at the cutting surface 710 (horizontal direction) and the height of the partition walls may be the lowest at the cutting surface 720 (vertical direction) so as to consecutively vary in height. In addition, the circumference thereof may be divided into four equal portions (divided at 45 degrees upward and downward about the center of the cutting surface 710), thereby causing the partition walls to differ in height with each other. Specifically, the opposing partition walls may have the same height such that the adjacent partition walls differ in height with each other. The same can be applied to a case of the lens having an elliptical shape.

FIGS. 8A to 8D are explanatory diagrams showing examples of the element lens having an elliptical shape. In the elliptical-shaped lens, it shows that the height of the partition walls in the major axis direction is different from the height of the partition walls in the minor axis direction, and the entire partition walls are the same in height with each other. That is, FIG. 8A shows the shape of the lens viewed from the upper direction (head on direction), and FIGS. 8B and 8C respectively show the shapes of a cutting surface 810 and a cutting surface 820. The length of the major axis is different from the length of the minor axis, and the partition walls differ in height with each other. Therefore, the curvature of the cutting surface 810 is different from the curvature of the cutting surface 820. FIGS. 8B and 8D show that the partition walls are the same in height with each other in the major axis direction and minor axis direction. However, the length of the major axis is different from the length of the minor axis. Therefore, the curvature of the cutting surface 810 is different from the curvature of the cutting surface 820. In the example, FIG. 8B is an example of the small curvature and FIG. 8D is an example of the large curvature. In this way, in a case where each element lens has an elliptical shape, even if the partition walls have uniform height, curvature in the major axis direction is different from the curvature in the minor axis direction. However, since curvature thereof depends on the ratio of the major axis length to the minor axis length of the lens, degree of design flexibility is small. In order to aggressively control both of the curvatures thereof, it is preferable that the partition walls differ in height with each other, thereby controlling both of the curvatures thereof.

The regulation in amounts of defocus of the lens will be described.

A changing lens has a short focal length (f_{S}), and a 3D lens has a long focal length (f_{L}).

A relational expression of focal length f, radius of curvature R and refraction index n is as follows.

f=R/(n−1)

Here, it is preferable that the amounts of defocus of the focal length (f_{L}) for the 3D lens is 15% (of f_{L}) or less, and the amounts of defocus of the focal length (f_{S}) for the changing lens is 20% (of f_{S}) or less.

It is further preferable that the amounts of defocus of the focal length (f_{L}) for the 3D lens is 5% (of f_{L}) or less, and the amounts of defocus of the focal length (f_{S}) for the changing lens is 10% (of f_{S}) or less.

Therefore, the curvature of each element lens is determined to obtain the amounts of defocus thereof. That is, the height of the first partition walls, the height of the second partition walls, and the length of each element lens in height and width are determined to obtain the amounts of defocus thereof.

In the above-described manufacturing using a mold, the substrate and the lens are integrally manufactured. However, after the substrate is manufactured, the lens array may be manufactured by performing treatment equivalent to that of FIGS. 3A to 3D and 4 described above.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A lens array comprising:
a plurality of lenses,
wherein each lens has a curvature in a first direction and a curvature in a second direction which is different from the first direction, the curvatures being different from each other.

2. The lens array according to claim 1, wherein the first direction and the second direction are substantially orthogonal to each other.

3. The lens array according to claim 1, wherein a shape of the lens is selected from a polygonal shape, a circularity shape and an elliptical shape.

4. The lens array according to claim 1, wherein the amount of defocus of the lens is 20% or less of the short focal length.

5. The lens array according to claim 1, wherein the amount of defocus of the lens is 15% or less of the long focal length.

6. The lens array according to claim 1, wherein the amount of defocus of the lens is 10% or less of the short focal length.

7. The lens array according to claim 1, wherein the amount of defocus of the lens is 5% or less of the long focal length.

8. A method of manufacturing a lens array comprising:
forming a substrate, where a height of a first partition wall that forms a first portion of the periphery of a lens and a height of a second partition wall that forms a second portion of the periphery of the lens are different from each other; and
filling a polymer into a region surrounded by the first partition walls and the second partition walls on the substrate.

9. The method of manufacturing a lens array according to claim 8, wherein each lens configuring the lens array, has a curvature in a first direction and a curvature in a second direction which is different from the first direction, the curvatures being different from each other.

10. The method of manufacturing a lens array according to claim 9, wherein the lens array has the first direction and the second direction that are substantially orthogonal to each other.

11. The method of manufacturing a lens array according to claim 8, wherein a shape of the lens is selected from a polygonal shape, a circularity shape and an elliptical shape.

12. A method of manufacturing a lens array, the method comprising:
forming a substrate, where a shape of each lens on the lens array is rectangular or elliptical and heights of partition walls that form the periphery of each lens are the same; and
forming the lens by filling a polymer into a region surrounded by the partition walls on the substrate.

13. The method of manufacturing a lens array according to claim 12, wherein each lens configuring the lens array, has a curvature in a first direction and a curvature in a second direction which is different from the first direction, the curvatures being different from each other.

14. The method of manufacturing a lens array according to claim 13, wherein the lens array has the first direction and the second direction that are substantially orthogonal to each other.
